(19) United States
(12) Patent Application Publication
(10) Pub. No.: US 2011/0249946 A1
(43) Pub. Date: Oct. 13, 2011

(54) OPTO ELECTRICAL CONVERTING MODULE AND COMPONENT USED FOR THE SAME

(75) Inventors: Tooru NAKANISHI, Yokohama-shi (JP); Mitsuaki TAMURA, Yokohama-shi (JP); Kiyoshi KATOU, Yokohama-shi (JP)

(73) Assignee: SUMITOMO ELECTRIC INDUSTRIES, LTD., Osaka-shi (JP)

(21) Appl. No.: 13/082,771

(22) Filed: Apr. 8, 2011

(30) Foreign Application Priority Data
Apr. 9, 2010 (JP) 2010-090288

(51) Int. Cl. G02B 6/36

(52) U.S. Cl. 385/88

(57) ABSTRACT

An opto electrical converting module-purpose component includes an optical fiber positioning component having an edge plane, a light emitting element provided on the edge plane, a light receiving element provided on the edge plane, a plurality of leads provided on the edge plane, which are electrically connected to the light emitting element and the light receiving element respectively, and a transimpedance amplifier is provided on the optical fiber positioning component. The edge plane has a plurality of through-holes into which optical fibers are inserted to be fixed.

### TECHNICAL FIELD

The present disclosure relates to a component used for an opto electrical converting module, the component capable of mutually converting an electrical signal and an optical signal, and an opto electrical converting module using the component.

### RELATED ART

In connection with large capacities and high-speed operations of current communication networks and improvements in process capabilities of supercomputers, improvements in transmission speeds are required, so that specific attentions have been paid to optical interconnection techniques. This optical interconnection technique intends to improve transmission speeds by using opto electrical converting modules in order to connect therewith signal processing devices such as LSIs, or to connect the signal processing devices with external interfaces such as routers, and replacing electrical signals between appliances with optical signals.

An opto electrical converting module is described in a patent publication 1. An opto electrical converting header (opto electrical converting module) described in the patent publication 1 has an optical waveguide member (optical fiber), a ferrule which holds and positions the optical waveguide member, an electric wiring line (lead) provided on the ferrule, and a surface type optical element (either light emitting element or light receiving element) mounted on the ferrule and connected to the electric wiring line.

### RELATED ART PUBLICATION

### Patent Publication

[Patent Publication 1] JP-A-2008-299062 Publication

The opto electrical converting module described in the patent publication 1 discloses that only one of the light emitting element and the light receiving element is mounted on the single ferrule. However, in order to meet with compactness requirements of appliances, it is desirable to realize such an opto electrical converting module capable of mutually converting optical and electrical signals, in which a single ferrule is equipped with two sorts of opto electrical converting elements, namely, a light emitting element for converting the electrical signal into the optical signal, and a light receiving element for converting the optical signal into the electrical signal.

### SUMMARY

As a result, as indicated in FIG. 7, inventors of the present invention conceived to realize an opto electrical converting module 100A capable of mutually converting optical and electrical signals, in which two sorts of opto electrical converting elements, namely, a light receiving element and a light emitting element, are provided in a single component 101 used for opto electrical converting module (which is hereinafter referred as opto electrical converting module-purpose component 101).

In FIG. 7, the opto electrical converting module 100A according to the reference example has the opto electrical converting module-purpose component 101, a driver IC 105, a transimpedance amplifier 106, a lead 107a and a wire 107b, a lead 108a and a wire 108b and a mounting board 110. The opto electrical converting module-purpose component 101 includes a ferrule 102 for positioning optical fibers 109. A light emitting element 103 and a light receiving element 104 are mounted on the opto electrical converting module-purpose component 101. The driver IC 105 drives the light emitting element 103. The transimpedance amplifier 106 amplifies a signal of the light receiving element 104. The lead 107a and the wire 107b connect the light emitting element 103 to the driver IC 105. The lead 108a and the wire 108b connect the light receiving element 104 to the transimpedance amplifier 106. The mounting board 110 supports these structural components.

However, if both the light receiving element 103 and the light emitting element 104 are provided on the single opto electrical converting module-purpose component 101, then large crosstalk noise is produced in an electrical signal outputted from the light receiving element 103. This reason is conceivable by that the crosstalk noise is produced due to the below-mentioned mechanism.

In general, since the light receiving element 104 outputs a very small current (10 μA) in response to an amount of received light, this outputted very small current is amplified by the transimpedance amplifier 106 and is derived as a voltage signal (200 mV). A current on the order of 10 mA is supplied from the driver IC 105 to the light emitting element 103 in response to an electrical signal, so that an optical signal is outputted therefrom.

At this time, a relatively large current for driving the light emitting element 103 flows through the lead 107a and the wire 107b, which connect the light emitting element 103 with the driver IC 105. On the other hand, the very small current produced from the light receiving element 104 before being amplified flows through the lead 108a and the wire 108b, which connect the light receiving element 104 with the transimpedance amplifier 106.

As a consequence, as shown in FIG. 7, when both the light emitting element 103 and the light receiving element 104 are provided on the single ferrule 102, the large current flowing through the wire 107b may especially give an adverse influence to the very small current flowing through the wire 108b. Therefore, noise may be mixed with the current signal inputted to the transimpedance amplifier 106. The inventors of the present invention conceived that since the transimpedance amplifier 106 amplifies the current signal mixed with the noise, the amplified noise is mixed into the output signal obtained from the transimpedance amplifier 106.

Exemplary embodiments of the present invention provide an opto electrical converting module-purpose component capable of mutually converting an optical signal and an electrical signal, and capable of obtaining a low noise output signal, and provide an opto electrical converting module using the opto electrical converting module-purpose component.

An opto electrical converting module-purpose component according to an exemplary embodiment of the invention comprises:

an optical fiber positioning component having an edge plane;

a light emitting element provided on the edge plane;

a light receiving element provided on the edge plane;

a plurality of leads provided on the edge plane, which are electrically connected to the light emitting element and the light receiving element respectively; and

a transimpedance amplifier is provided on the optical fiber positioning component,

wherein the edge plane has a plurality of through-holes into which optical fibers are inserted to be fixed.

In the opto electrical converting module-purpose component, the transimpedance amplifier and the light receiving element may be mounted on the edge plane; and

the transimpedance amplifier may be connected to the light receiving element and the lead by wire bonding.

In the opto electrical converting module-purpose component, the transimpedance amplifier may be provided on a plane which is elongated substantially parallel to an array plane of the plurality of through-holes in the optical fiber positioning component; and

the transimpedance amplifier may be connected to the light receiving element by wire bonding.

An opto electrical converting module according to an exemplary embodiment of the invention comprises:

a mounting board;

the opto electrical converting module-purpose component, and mounted on the mounting board;

a plurality of optical fibers inserted to be fixed in the opto electrical converting module-purpose component; and

a drive unit provided on the mounting board, and configured to drive the light emitting element.

In accordance with the opto electrical converting module-purpose component according to the present invention, the light receiving element and the light emitting element are provided on the same edge plane of the optical fiber positioning component, and thus, the output path through which the very small current signal outputted by the light receiving element flows is arranged in the vicinity of the light emitting element. However, since the transimpedance amplifier is provided on the optical fiber positioning component where the light receiving element is provided, the distance between the light receiving element and the transimpedance amplifier is shortened, so that the output path between the light receiving element and the transimpedance amplifier can be made short.

As a consequence, the output path from the light receiving element which is influenced by the noise caused by the light emitting element through which the large current flows and the lead connected to the light emitting element can be made short. Therefore, the opto electrical converting module-purpose component by which the electrical signal containing the low noise can be derived, and the opto electrical converting module using the opto electrical converting module-purpose component can be provided.

### BRIEF DESCRIPTION OF THE DRAWINGS

FIG. 1 is a perspective view of an opto electrical converting module according to a first embodiment of the present invention.

FIG. 2 is a front view of an opto electrical converting module-purpose component according to the first embodiment of the present invention.

FIG. 3 is a front view of an opto electrical converting module-purpose component according to a modification of the first embodiment of the present invention.

FIG. 4 is a perspective view of an opto electrical converting module according to a second embodiment of the present invention.

FIG. 5 is a perspective view of an opto electrical converting module according to a third embodiment of the present invention.

FIG. 6 is a perspective view of an opto electrical converting module according to a fourth embodiment of the present invention.

FIG. 7 is the perspective view of the opto electrical converting module according to the reference example.

### DETAILED DESCRIPTION

Referring to accompanying drawings, a description is made of embodiments of the present invention.

### First Embodiment

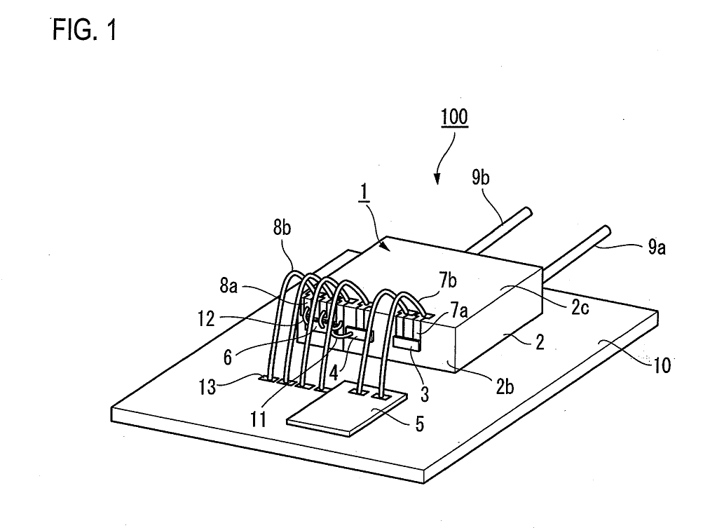

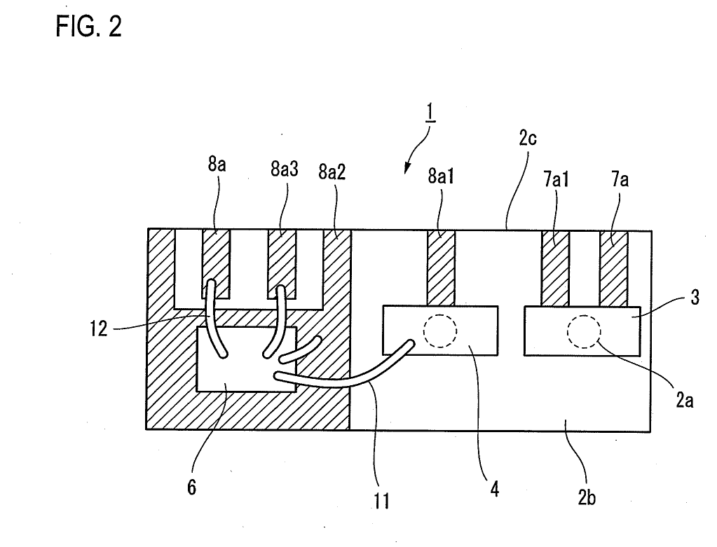

An opto electrical converting module 100 using an opto electrical converting module-purpose component 1 according to a first embodiment of the present invention will be explained by referring to FIG. 1 and FIG. 2. FIG. 1 is a perspective view of the opto electrical converting module 100, and FIG. 2 is a front view of the opto electrical converting module-purpose component 1.

Referring to FIG. 1, the opto electrical converting module-purpose component 1 according to the first embodiment has a ferrule (optical fiber positioning component) 2, a light emitting element 3, a light receiving element 4, a lead 7a, a lead 8a, and a transimpedance amplifier 6. The ferrule 2 holds optical fibers 9a and 9b to position the optical fibers 9a and 9b. The light emitting element 3 emits an optical signal in response to an electrical signal. The light receiving element 4 produces an electrical signal in response to a received optical signal. The lead 7a is electrically connected to the light emitting element 3. The lead 8a is electrically connected to the light receiving element 4. The transimpedance amplifier 6 amplifies an output of the light receiving element 4.

The opto electrical converting module-purpose component 1 constructs the opto electrical converting module 100 in combination with the optical fibers 9a and 9b, a driver IC (drive unit) 5, an output terminal 13, a wire 7b, a wire 8b and a mounting board 10. The optical fibers 9a and 9b are inserted into the ferrule 2 so as to be positioned and fixed therein. The driver IC (drive unit) 5 drives the light emitting element 3. The output terminal 13 outputs the electrical signal derived from the light receiving element 4 to an external unit (not shown). The wire 7b transfers an electrical signal from the driver IC 5 to the light emitting element 3. The wire 8b transfers an electrical signal from the light receiving element 4 to the output terminal 13. The opto electrical converting module-purpose component 1, the driver IC 5, and the output terminal 13 are mounted on the mounting board 10.

The ferrule 2 is a substantially rectangular parallelepiped-shaped member which is manufactured by metal molding of an epoxy resin, or the like, and is mounted on the mounting board 10 under the condition that a bottom plane thereof is located opposite to this mounting board 10. While through-holes 2a (refer to FIG. 2) elongated parallel to the mounting board 10 are formed inside the ferrule 2, the through-holes 2a are opened at an edge plane 2b which is an element mounting plane of the ferrule 2. The optical fibers 9a and 9b are inserted into the through-holes 2a, and are positioned in such a manner that edge planes of the optical fibers 9a and 9b are located opposite to either the light receiving element 4 or the light emitting element 3 via a small gap between them. With this structure, it is avoided that the edge planes of the optical fibers 9a and 9b are contacted to either the light receiving element 4 or the light emitting element 3, so that the light receiving element 4, or the light emitting element 3 is damaged.

In the present embodiment, two sets of the optical fibers 9a and 9b constituted by an input-purpose optical fiber 9a to be connected to the light emitting element 3 and an output-purpose optical fiber 9b to be connected to the light receiving element 4 are connected to the ferrule 2. These two optical fibers 9a and 9b are arrayed parallel to either the mounting board 10 or an upper plane 2c of the ferrule 2. In other words, the array planes of the optical fibers 9a and 9b are located substantially parallel to the upper plane 2c of the ferrule 2.

On the edge plane 2b of the ferrule 2 in which the through-holes 2a are opened, a light emitting area of the light emitting element 3 and a light receiving area of the light receiving element 4 are mounted in such a manner that these light emitting and receiving areas are located opposite to the edge planes of the input-purpose and output-purpose optical fibers 9a and 9b respectively. The lead 7a having an electric conductivity which is electrically connected to the light emitting element 3, and the lead 8a having an electric conductivity which is electrically connected to the light receiving element 4 are formed on the edge plane 2b of the ferrule 2 by sputtering, plating, or the like. The leads 7a and 8a are elongated to the upper plane 2c of the ferrule 2 to be formed, and are connected to the driver IC 5 and the output terminal 13 by the wires 7b and 8b by wire bonding.

The light emitting element 3 emits an optical signal in response to a current signal outputted from the driver IC 5 mounted on the mounting board 10, and transfers the optical signal via the input-purpose optical fiber 9a to an external appliance (not shown). As the light emitting element 3, a semiconductor light emitting laser such as a VCSEL (Vertical Cavity Surface Emitting LASER) which emits light in response to a voltage may be employed. The light emitting element 3 is electrically connected to the driver IC 5 fixed on the mounting board 10 via the lead 7a and the wire 7b.

The light receiving element 4 outputs an electrical signal in response to the optical signal inputted via the output-purpose optical fiber 9b from the external appliance (not shown). As the light receiving element 4, a photodiode may be employed which generates a current signal in response to an amount of received light. Since the current signal outputted from the light receiving element 4 is very small, this very small current signal is amplified by the transimpedance amplifier 6.

While the transimpedance amplifier 6 is also provided on the edge plane 2b of the ferrule 2 on which the light emitting element 3 and the light receiving element 4 are provided, the transimpedance amplifier 6 is connected to the light receiving element 4 via a wire 11 by wire bonding. Furthermore, an output signal of the transimpedance amplifier 6 is outputted to the output terminal 13 via a wire 12, the lead 8a, and the wire 8b. This transimpedance amplifier 6 is provided on the opposite side of the light emitting element 3 with respect to the light receiving element 4.

A structure of the edge plane 2b of the ferrule 2 will be explained in more detail with reference to FIG. 2. FIG. 2 is a front view of the opto electrical converting module-purpose component 1 according to the first embodiment of the present invention, and indicates the edge plane 2b of the ferrule 2.

Two pieces of leads 7a and 7a1 are elongated from the light emitting element 3 which is mounted to the edge plane 2b of the ferrule 2, and extend into the upper plane 2c of the ferrule 2. Among these leads, the lead 7a transfers a current signal (drive current) for causing the light emitting element 3 to emit light. The lead 7a1 is the ground line of the light emitting element 3, and is connected with an external ground conductor (not shown).

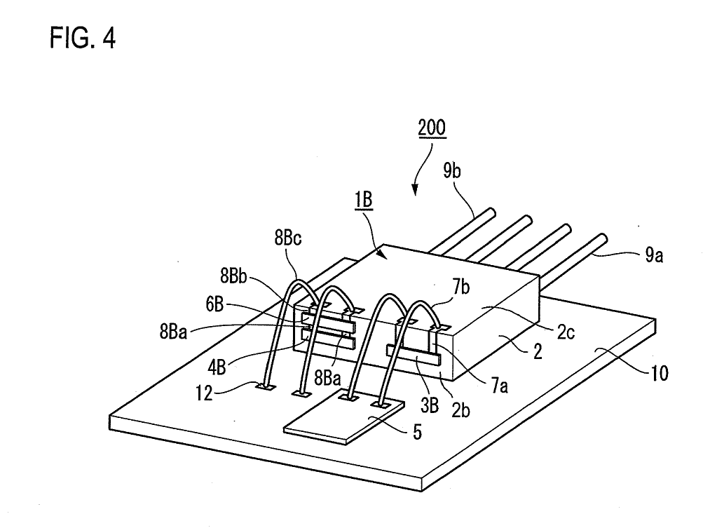

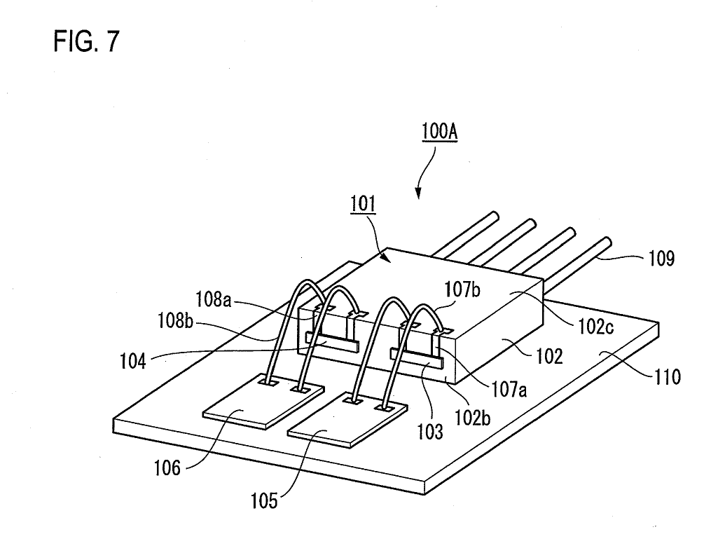

One piece of a lead 8a1 is also elongated from the light receiving element 4, and extends into the upper plane 2c of the ferrule 2. The lead 8a1 is the ground line of the light receiving element 4. The lead 8a1 is connected to the external ground conductor in a similar manner to the lead 7a1. (In the below-mentioned description, a description is made by paying attention to leads 7a and 8a, and wires 7b and 8b, which transfer signal of either light emitting element 3 or light receiving element 4. In opto electrical converting modules represented in FIG. 4 to FIG. 7 which will be explained below, only leads 7a and 8a, and wires 7b and 8b, which transfer electrical signals, are indicated, and ground lines are omitted.).

Around the transimpedance amplifier 6, the lead 8a for transferring an output signal of the transimpedance amplifier 6 to the output terminal 13 (refer to FIG. 1), a ground-purpose lead 8a2 of the transimpedance amplifier 6, and a lead 8a3 for supplying electric power so as to operate the transimpedance amplifier 6 are provided.

As previously described, the light receiving element 4 is connected to the transimpedance amplifier 6 by the wire 11 by wire bonding, and the transimpedance amplifier 6 is also connected to the lead 8a by the wire 12 by wire bonding. The transimpedance amplifier 6 is connected to other leads 8a1 to 8a3 by wire bonding, respectively.

As shown in FIG. 1, the respective leads 7a to 8a3 are formed in such a manner that these leads 7a to 8a3 are elongated and extend into the upper plane 2c of the ferrule 2. Therefore, these leads 7a to 8a3 can be easily connected to the driver IC 5 and the output terminal 13 by wire bonding, which are provided on the mounting board 10, and the terminals of which are exposed from the upper plane.

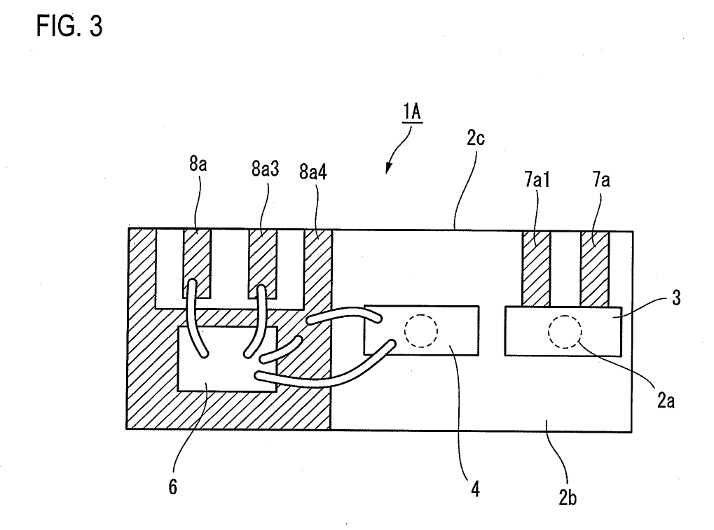

While the configuration of the edge plane 2b of the ferrule 2 is one example, as shown in FIG. 3, an opto electrical converting module-purpose component 1A according to a modification of the first embodiment may be accomplished in which the ground electrodes of the light receiving element 4 and the transimpedance amplifier 6 are commonly utilized as a lead 8a4. Although not shown, the ground electrodes of the light emitting element 3, the light receiving element 4, and the transimpedance amplifier 6 may be alternatively utilized as a common ground electrode.

In accordance with the opto electrical converting module 100 using the opto electrical converting module-purpose component 1, since the light emitting element 3 and the light receiving element 4 are mounted on the single ferrule 2, it is possible to provide a compact opto electrical converting module 100 capable of mutually converting an optical signal and an electrical signal.

Furthermore, the transimpedance amplifier 6 and the light receiving element 4 are provided on the same edge plane 2b of the ferrule 2 so as to shorten the distance between these elements 4 and 6, so that the output path (wire 11) through which the very small current signal flows from the light receiving element 4 can be shortened. As a result, the wire 11 which may be easily affected by the noise generated from the lead 7a and the wire 7b of the light emitting element 3 through which the relatively large current flows can be made short. Further, the transimpedance amplifier 6 amplifies a signal containing a small amount of noise outputted from the light receiving element 4, so that the output signal having the small amount of noise can be obtained from the light receiving element 4.

Further, the transimpedance amplifier 6 is provided on the opposite side of the light emitting element 3 with respect to the light receiving element 4. Therefore, the wire 11 through which the very small current signal flows can be formed at the position separated from the light emitting element 3, so that the noise can be more hardly mixed into the output signal from the light receiving element 4.

Since the output signal derived from the light receiving element 4 via the wire 11 and amplified by the transimpedance amplifier 6 has a magnitude equivalent to a strength of a signal flowing through the lead 7a and the wire 7b, an adverse influence of noise caused by the lead 7a and the wire 7b is low.

### Second Embodiment

The opto electrical converting module 100 using the opto electrical converting module-purpose component 1 according to the first embodiment is configured by being equipped with one set of the output-purpose optical fiber 9a which is connected to the light emitting element 3 and the input-purpose optical fiber 9b which is connected to the light receiving element 4 respectively. However, an opto electrical converting module may be alternatively configured by being equipped with a plurality of input-purpose and output-purpose optical fibers 9a and 9b.

FIG. 4 is a perspective view of an opto electrical converting module 200 using an opto electrical converting module-purpose component 1B according to a second embodiment of the present invention. While the opto electrical converting module 200 is a modification of the opto electrical converting module 100, the same reference numerals are applied to similar structural members, and detailed descriptions thereof are omitted.

In the opto electrical converting module 200, plural pieces (4 pieces in illustrated example) of input-purpose and output-purpose optical fibers 9a and 9b are connected to the ferrule 2. Among these optical fibers, two pieces of the input-purpose optical fibers 9a are connected to a light emitting unit 3B where two light emitting elements are collected within a single unit, and two pieces of the remaining output-purpose optical fibers 9b are connected to a light receiving unit 4B where two light receiving elements are collected within a single unit. The light emitting unit 3B and the light receiving unit 4B are mounted on the edge plane 2b of the ferrule 2, respectively.

Similar to the light receiving unit 4B, a transimpedance amplifier 6B has a narrow shape along the array direction of the output-purpose optical fibers 9b, and is arranged on the edge plane 2b of the ferrule 2 on the side of the upper plane 2c of the ferrule 2, which is located higher than the light receiving unit 4B. While the transimpedance amplifier 6B is connected via a lead 8Ba to the respective light receiving elements of the light receiving unit 4B, a lead 8Bb is elongated from the transimpedance amplifier 6B up to the upper plane 2c of the ferrule 2. Moreover, the lead 8Bb is connected via a wire 8Bc to an output terminal 12.

Similarly, in the opto electrical converting module 200 according to the present embodiment, the transimpedance amplifier 6B is provided on the edge plane 2b of the ferrule 2. Therefore, a distance between the light receiving unit 4B and the transimpedance amplifier 6B is made short, and an output path (lead 8Ba) through which a very small current flows from the light receiving unit 4B is configured to be shortened. As a consequence, in accordance with the opto electrical converting module 200 according to the present embodiment, the plurality of optical signals can be inputted and outputted, and an output signal containing low noise can be obtained from the light receiving unit 4B similar to the first embodiment.

### Third Embodiment

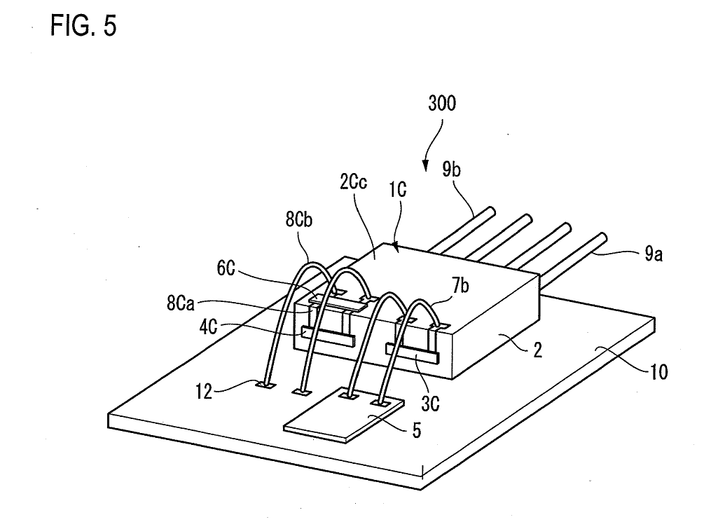

Although the transimpedance amplifiers 6 and 6B have been provided on the edge plane 2b of the ferrule 2 in the first and second embodiments, a transimpedance amplifier may be alternatively provided on any place other than the edge plane 2b of the ferrule 2. FIG. 5 is a perspective view of an opto electrical converting module 300 using an opto electrical converting module-purpose component 1C according to a third embodiment of the present invention. While the opto electrical converting module 300 is a modification of the opto electrical converting module 200, the same reference numerals are applied to similar structural members, and detailed descriptions thereof are omitted.

In the opto electrical converting module 300, a light emitting unit 3C and a light receiving unit 4C are provided on the edge plane 2b of the ferrule 2, and a transimpedance amplifier 6C is mounted at a position within the upper plane 2Cc of the ferrule 2, which is located near the light receiving unit 4C. The light receiving unit 4C is connected to the transimpedance amplifier 6C by a lead 8Ca which is formed from the edge plane 2b to the upper plane 2Cc, and furthermore, the lead 8Ca is connected to an output terminal 12 by a wire 8Cb.

In accordance with the opto electrical converting module 300, an output path (lead 8Ca) through which a very small current flows from the light receiving unit 4C can be made shorter, as compared with such a case that the transimpedance amplifier 6C is mounted on the mounting board 10, so that an output signal containing low noise can be obtained from the light receiving unit 4C similar to the above-described embodiments.

The opto electrical converting module 300 can have a specific advantage when an area of the edge plane 2b of the ferrule 2 cannot be made large, and a dimension of the ferrule 2 along a height direction (upper/lower direction of FIG. 5) cannot be made large.

### Fourth Embodiment

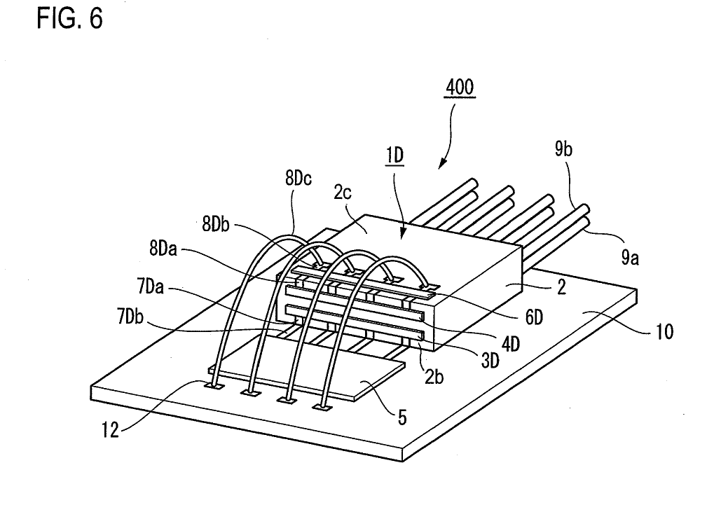

FIG. 6 is a perspective view of an opto electrical converting module 400 using an opto electrical converting module-purpose component 1D according to a fourth embodiment of the present invention. The opto electrical converting module 400 is configured by storing a plurality of optical fibers 9a and 9b in a single ferrule 2, the total number of which is furthermore larger than that of the above-described embodiments. While the opto electrical converting module 400 is a modification of the opto electrical converting module 200, the same reference numerals are applied to similar structural members, and detailed descriptions thereof are omitted.

In the opto electrical converting module 400, the input-purpose optical fibers 9a which are connected to a light emitting unit 3D are arrayed by being collected in a lower layer, and the output-purpose optical fibers 9b which are connected to a light receiving unit 4D by being collected in an upper layer. An array plane of the plurality of input-purpose optical fibers 9a, and an array plane of the plurality of output-purpose optical fibers 9b are located parallel to the upper plane 2c of the ferrule 2, respectively.

In order to meet with a corresponding relationship with these optical fibers 9a and 9b, the light emitting unit 3D is provided on a lower side (on the side of mounting board 10) of the edge plane 2b of the ferrule 2; the light receiving unit 4D is provided on an upper side of the edge plane 2b of the ferrule 2; and a transimpedance amplifier 6D is provided on the upper plane 2c of the ferrule 2.

A lead 7Da is elongated from the light emitting unit 3D on the side of the mounting board 10, and is connected to the driver IC 5 via a lead 7Db wired on the mounting board 10.

On the other hand, while a lead 8Da elongated from the light receiving unit 4D is formed in such a manner that the lead 8Da extends into the upper plane 2c of the ferrule 2, this lead 8Da connects the light receiving unit 4D which is provided on the edge plane 2b of the ferrule 2 to the transimpedance amplifier 6D which is provided on the upper plane 2c of the ferrule 2.

As previously described, similarly in the present embodiment, the lead 8Da for connecting the light receiving unit 4D to the transimpedance amplifier 6D can be made shorter, as compared with such a case that the transimpedance amplifier 6D is provided on the mounting board 10. Further, the transimpedance amplifier 6D is provided on the opposite side of the light emitting unit 3D with respect to the light receiving unit 4D, so that an output signal containing low noise can be obtained from the light receiving unit 4D.

While the present invention has been described in detail or with reference to the specific embodiments, it is apparent to a person skilled in the art that various sorts of changes and modifications may be applied thereto without departing from the technical scope and spirit of the present invention.

What is claimed is:

1. An opto electrical converting module-purpose component comprising:
an optical fiber positioning component having an edge plane;
a light emitting element provided on the edge plane;
a light receiving element provided on the edge plane;
a plurality of leads provided on the edge plane, which are electrically connected to the light emitting element and the light receiving element respectively; and
a transimpedance amplifier is provided on the optical fiber positioning component,
wherein the edge plane has a plurality of through-holes into which optical fibers are inserted to be fixed.

2. An opto electrical converting module-purpose component as claimed in claim 1 wherein:
the transimpedance amplifier and the light receiving element are mounted on the edge plane; and
the transimpedance amplifier is connected to the light receiving element and the lead by wire bonding.

3. An opto electrical converting module-purpose component as claimed in claim 1 wherein:
the transimpedance amplifier is provided on a plane which is elongated substantially parallel to an array plane of the plurality of through-holes in the optical fiber positioning component; and
the transimpedance amplifier is connected to the light receiving element by wire bonding.

4. An opto electrical converting module comprising:
a mounting board;
the opto electrical converting module-purpose component recited in claim 1, and mounted on the mounting board;
a plurality of optical fibers inserted to be fixed in the opto electrical converting module-purpose component; and
a drive unit provided on the mounting board, and configured to drive the light emitting element.
